(19) United States
(12) Patent Application Publication
(10) Pub. No.: US 2024/0402509 A1
(43) Pub. Date: Dec. 5, 2024

(54) Polarization Changing Structures

(71) Applicants: SINTEF TTO AS, Trondheim (NO); UNIVERSITY OF SOUTHERN DENMARK, Odense (DK)

(72) Inventors: Sergey Bozhevolnyi, Odense (DK); Chao Meng, Odense (DK); Fei Ding, Odense (DK); Paul Conrad Vaagen Thrane, Oslo (NO)

(21) Appl. No.: 18/692,533

(22) PCT Filed: Sep. 15, 2022
(86) PCT No.: PCT/GB2022/052337

§ 371 Date: Mar. 15, 2024

(30) Foreign Application Priority Data
Sep. 15, 2021 (GB) 2113182.6

(51) Int. Cl. G02B 27/28; G02B 1/00; G02B 7/182

(52) U.S. Cl. CPC G02B 27/286; G02B 1/002; G02B 7/182

(57) ABSTRACT

An apparatus (1) for adjustably changing the polarisation state of incident light having at least a first wavelength. The apparatus (1) includes a polarisation changing optical metasurface (OMS) (3) arranged to reflect light of a first polarisation state, and to transmit light of a second polarisation state, said second polarisation state being different to said first polarisation state. The apparatus (1) also includes a mirror (9) arranged to reflect the transmitted light of the second polarisation state, wherein the apparatus (1) is arranged to move the mirror (9) and/or the polarisation changing OMS (3) relative to one another to alter a separation between the polarisation changing OMS (3) and the mirror (9), thereby altering a phase difference between the light reflected by the polarisation changing OMS (3) and the light reflected by the mirror (9) such that a combined polarisation state of light reflected by the apparatus (1) is adjustable.

### FIELD OF THE DISCLOSURE

The present invention relates to polarization changing structures for changing the polarization of incident light.

### BACKGROUND

Polarization changing structures are used in many applications to alter the polarization of transmitted or reflected light with respect to the polarization state of incident light.

One example of known polarization changing structures are polarizers which operate by absorbing or deflecting light having a specific linear polarization, and thereby introduce power loss into the considered optical channel.

Another example of known polarization changing structures are polarization changing wave plates which do not impose a power loss but instead change the state of polarization by introducing a phase difference between two orthogonally polarized waves upon their transmission through a birefringent material for which the index of refraction is different for light linearly polarized along one or the other of two certain perpendicular crystal axes. By appropriate choice of the relationship between the thickness of the crystal, the wavelength of the light, and the variation of the index of refraction, it is possible to introduce a controlled phase shift between the two polarization components of a light wave, thereby altering its overall polarization state.

At present, waveplates are fabricated to achieve a specific output, for example, a waveplate may be configured as a half wave plate, or a quarter wave plate. In applications in which the desired polarization state of the output may change, it is typically necessary to swap between different waveplates. This not only limits the speed of operation, but also requires a suitable mechanical arrangement to deploy multiple different waveplates, the cost of which can be significant. Such mechanical arrangements are also typically relatively large, heavy and may not be fully reliable.

Tunable waveplates have been experimented with such as liquid crystal waveplates and Pockels cells. However, liquid crystal waveplates are slow to change configuration, whilst Pockels cells are prohibitively expensive and require very high voltage to operate.

### SUMMARY

According to a first aspect of the invention, there is provided an apparatus for adjustably changing the polarization state of incident light having at least a first wavelength, the apparatus comprising:
a polarization changing optical metasurface (OMS) arranged to reflect light of a first polarization state, and to transmit light of a second polarization state, said second polarization state being different to said first polarization state; and
a mirror arranged to reflect the transmitted light of the second polarization state, wherein the apparatus is arranged to move the mirror and/or the polarization changing OMS relative to one another to alter a separation between the polarization changing OMS and the mirror, thereby altering a phase difference between the light reflected by the polarization changing OMS and the light reflected by the mirror such that a combined polarization state of light reflected by the apparatus is adjustable.

According to a second aspect of the invention, there is provided a system comprising:
a light source configured to emit light of at least a first wavelength containing the first polarization state and the second polarization state; and
an apparatus as described in relation to the first aspect of the invention, wherein the light source and apparatus are arranged such that the light emitted by the light source is incident on the apparatus.

The light source of the system may emit unpolarized light, but in a set of embodiments, the light source is configured to emit linearly polarized light.

According to a third aspect of the invention, there is provided a method of adjustably changing the polarization state of incident light having at least a first wavelength, the method comprising:
reflecting light from said incident light having a first polarization state with a polarization changing optical metasurface (OMS);
transmitting light from said incident light having a second polarization state through said polarization changing OMS, said second polarization state being different to said first polarization state;
reflecting the transmitted light of the second polarization state with a mirror; and
moving the mirror and/or the polarization changing OMS in order to alter a separation between the polarization changing OMS and the mirror thereby altering a phase difference between the light reflected by the polarization changing OMS and the light reflected by the mirror such that a combined polarization state of light reflected by both the polarization changing OMS and the mirror is adjusted.

Thus it will be seen by those skilled in the art that in accordance with the invention, an adjustable polarization changing structure can be provided without having to provide a plurality of different wave plates which have to be moved. Moreover, since the overall polarization state may be dependent only on the separation of the mirror and the OMS, a greater number of different states may be achievable. For example, by adjusting the separation between the polarization changing OMS and the mirror in a continuous fashion, the polarization state of the overall reflected light can be continuously adjusted. This may provide greater flexibility, the ability to operate more quickly and lower cost.

In a set of embodiments the OMS is configured so that it predominantly reflects light of the first polarization, transmits light of the second polarization, independent of the separation between the OMS and the mirror.

In a set of embodiments, the apparatus is arranged such that said separation between the OMS and the mirror has a minimum value of at least 50 nm. In a further set of embodiments, the separation between the OMS and the mirror is at least 75 nm. In a set of embodiments, the apparatus is arranged such that the separation between the OMS and the mirror has a minimum value of at least 10% of the incident wavelength, i.e., the first wavelength. Where the incident light comprises a plurality of wavelengths, the first wavelength may be the shortest wavelength of the incident light.

In a set of embodiments, the apparatus is arranged such that the separation between the polarization changing OMS and the mirror has a maximum value of at most ten wavelengths, e.g., at most five wavelengths, e.g., one wavelength.

In a set of embodiments, the apparatus is arranged to alter the separation between the polarization changing OMS and the mirror between respective minimum and maximum values which differ by at least 700 nm, e.g., 725 nm; or by at least 450 nm, e.g., 425 nm. In one set of examples the minimum separation is 75 nm. In a set of examples the maximum separation is less than 1000 nm, e.g., 800 nm or less than 600 nm, e.g., 550 nm.

In a set of embodiments the apparatus is arranged to be able to alter the separation between the polarization changing OMS and the mirror between respective minimum and maximum values which differ by at least 9/10 of the first wavelength, or by at least 6/10 of the first wavelength. In one set of examples the minimum separation is 1/10 of the first wavelength.

In order to achieve good efficiency of the apparatus, low transmission of the first polarization state is of greater importance than high transmission of the second polarization state. In an ideal OMS, the transmission of the first polarization state would be 0%, and the transmission of the second polarization state would be 100%. Real world OMS' will be imperfect, and the inventors have appreciated that in the present application, it is better to sacrifice some transmission efficiency of the second polarization state to ensure that the percentage of the first polarization state which is transmitted by the OMS is low.

As discussed above, the OMS is arranged to reflect light of the first polarization state, and to transmit light of the second polarization state, but more particularly, in a set of embodiments, the OMS is arranged to transmit less than 10%, e.g., less than 5% of the light of the first polarization state. In an overlapping set of embodiments, the OMS is arranged to transmit more than 40% e.g., more than 50% of the light of the second polarization state. It will be understood that a proportion of the incident light may be absorbed by the OMS and by the mirror.

The OMS may be configured to achieve the respective reflection and transmission of the first and second polarization states with many different polarization states, having many different relationships between the polarization states, but in a set of embodiments, the OMS is arranged such that the first polarization state is orthogonal to the second polarization state.

The OMS may be constructed of any suitable material such as any suitable metal, for example, the OMS may be constructed from aluminum. However, in a set of embodiments, the OMS is constructed from gold.

The OMS may be constructed of a plurality of individual nanostructures. In a set of embodiments the nanostructures form a periodically repeating pattern. In a set of such embodiments the spatial period of the repeating pattern is less than the first wavelength.

In a set of embodiments the nanostructures have dimensions which are all less than the first wavelength.

In a set of embodiments, the nanostructures are each cuboidal in shape, and have a thickness which is smaller than both their length and width. It will be understood that the thickness of the nanostructures is measured along the axis which is substantially parallel to the direction of the incident light which the OMS is configured to manipulate. It will similarly be understood that the length and width of the nanostructures are measured in the plane which is substantially perpendicular to the direction of the incident light which the OMS is configured to manipulate.

The apparatus may adjust the separation between the OMS and the mirror by moving the OMS whilst keeping the mirror stationary, but in a set of embodiments, the apparatus is arranged to move the mirror relative to the OMS. In such a set of embodiments, the apparatus may further be arranged to move the OMS relative to the mirror, or to keep the OMS stationary relative to the mirror.

In embodiments where the apparatus is configured to move the mirror relative to the OMS, the mirror may be moved by any suitable means. However, in a set of embodiments, the mirror is a Micro-electromechanical systems (MEMS) mirror which is translatable upon application of a suitable voltage. In a set of embodiments the mirror comprises a feedback mechanism, e.g., a capacitive feedback mechanism to regulate its separation from the OMS and/or its degree of planarity.

The mirror may be constructed from any suitable material, however, in a set of embodiments, the mirror is constructed from gold.

In a set of embodiments, the system of the second aspect comprises a plurality of apparatuses as described in relation to the first aspect of the invention which may have different or identical characteristics to each other. In such embodiments, the apparatuses may be arranged such that incident light is reflected from a first apparatus, and then subsequently reflected from a second apparatus (i.e., in a serial arrangement). Alternatively or additionally, light from the light source could be divided into a plurality of beams, for example, by any known beam splitter, with each beam being reflected by a spate apparatus, before interferometrically recombining (i.e., in a parallel arrangement). Such embodiments may enable more complex polarization changes and beam properties to be realized.

It will be seen by those skilled in the art that the invention may have a plurality of potential applications. For example, the apparatus may be used as a stand-alone component in optical setups, replacing the many separate dedicated waveplates which are currently used. Further, the invention may be used in compact and lightweight ellipsometry devices, performing functions such as material characterization, bio-sensing, and optical communication. The invention may also be used for light projection with polarization control by reflecting light from the apparatus before projecting the light. Such light projection may be useful for machine vision, where polarization information could provide more details on surface profile, materials and edge locations, 3-dimensional measurements with surface profile information, optical communication, and super resolution microscopy. The above applications are provided as examples only, and the skilled person will appreciate that the possible applications of the present invention are not limited to the examples discussed above.

In the current disclosure, it will be understood that a polarization changing optical metasurface (OMS) is an artificial sheet material having sub-wavelength thickness, and sub-wavelength scaled patterns in the planar dimensions which are formed by nanostructures. The polarization changing OMS has differing transmission and reflection properties for different polarization states and is able to manipulate radiation wavefronts at a subwavelength scale.

The features described above in relation to different aspects and embodiments of the present invention may be combined in various combinations. It will be understood that the combination of features in the following description and drawings are intended to be illustrative, and are non-limiting.

### BRIEF DESCRIPTION OF THE DRAWINGS

An embodiment of the invention will now be described, by way of example only, with reference to the accompanying drawings in which:

FIG. 1 is a schematic diagram of an apparatus in accordance with an embodiment of the present invention;

FIG. 2 is a schematic top-down view of an optical metasurface in accordance with an embodiment of the present invention;

FIG. 3 is a graph showing the normalized transmission of two polarization states through the OMS of FIG. 2 plotted against the wavelength of the incident light;

FIG. 4 is a graph showing the normalized reflection of two polarization states from the OMS of FIG. 2, plotted against the wavelength of the incident light;

FIG. 5 shows the apparatus of FIG. 1 with the mirror in a raised position;

FIG. 6 is a flow diagram illustrating a method in accordance with the present invention;

FIG. 7 is a graph showing the normalized reflection of two polarization states from the apparatus of FIG. 1, plotted against the size of the gap;

FIG. 8 is a graph showing the phase of two polarization states, and the phase difference between the two polarization states plotted against the size of the gap;

FIG. 9 shows an OMS with an alternative nanostructure geometry to that shown in FIG. 2;

FIG. 10 shows a further OMS with an alternative nanostructure geometry to those shown in FIG. 2 and FIG. 9; and

FIG. 11 shows another OMS with an alternative nanostructure geometry.

### DETAILED DESCRIPTION

In the below description, terms such as raised, high, low, height, and top are used. It will be understood that these terms refer to the orientation of the accompanying drawings, in which the light incident on the apparatus originates from the top of the drawings.

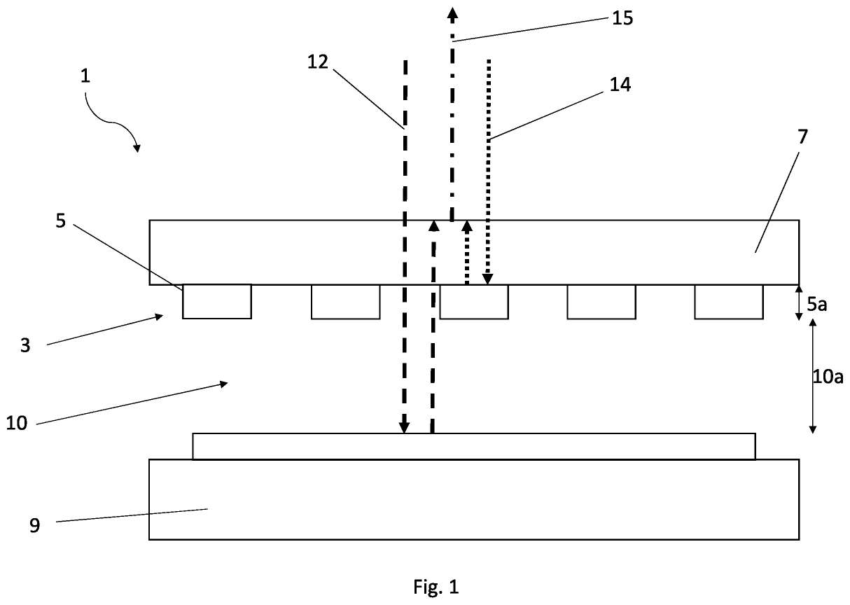

FIG. 1 is a schematic diagram of an apparatus 1 according to an embodiment of the invention. The apparatus 1 comprises an optical metasurface (OMS) 3 which is comprised of a plurality of nanostructures 5. The structure of the OMS 3 is discussed in detail below. The OMS 3 is mounted on a glass substrate 7 such that the incident light passes through the glass substrate before reaching the OMS 3. The substrate 7 provides mechanical protection of the device from the environment. Use of glass is not essential—other optically transmissive materials could be used depending on the wavelengths of light being used. For example, in other embodiments a silicon substrate could be used as this is typically transmissive in the infra-red range. This could be advantageous in allowing the OMS to be mounted on a MEMS actuator with the mirror remaining static.

Anti-reflective coatings can be used on the surface of the substrate 7 in order to increase the efficiency of device by reducing unwanted reflection, for example, from the surface of the substrate 7 which incident light first encounters before reaching the OMS 3.

The apparatus 1 further comprises a mirror 9 which in the illustrated embodiment is an ultra-flat MEMS mirror having a gold reflective surface The mirror is, for example, constructed as described in Bakke, Thor, and Ib-Rune Johansen. “A robust, non-resonant piezoelectric micromirror.” 16th International Conference on Optical MEMS and Nanophotonics. IEEE, 2011, the contents of which is incorporated herein by reference. The mirror 9 is designed to move across the range from a minimum separation of 75 nm from the OMS 3 to a maximum separation of 600 nm from the OMS 3. Further, if the resting position of the mirror, when there is no voltage actuating the mirror, is more than 600 nm away from the OMS 3, then the mirror 9 must also be designed to move across the distance between the resting position and 600 nm, in addition to moving across the separation range from 600 nm to 75 nm. The abovementioned range of movement can be achieved with a driving voltage of up to two volts.

To get the same polarization change across the whole device it is advantageous to have the reflecting surface of the mirror as flat as possible, to within 20 nm across the whole area which overlaps the OMS 3. There may be small (compared to the OMS area) particles or uneven areas that exceed this height difference, but they should not protrude so far above the surface that they physically hinder the movement of the mirror.

The space between the OMS 3 and the mirror 9 forms a gap 10. The MEMS mirror 9 is configured to move relative to the substrate 7 and OMS 3 upon application of a suitable voltage such that the size 10a of the gap 10 between the OMS and the mirror 9 can be adjusted. In FIG. 1, light incident on the apparatus 1 is shown to contain light which is linearly polarized along the Y axis 12, and light which is linearly polarized along the X axis 14. The figure also shows the light 15 which is reflected by the apparatus 1.

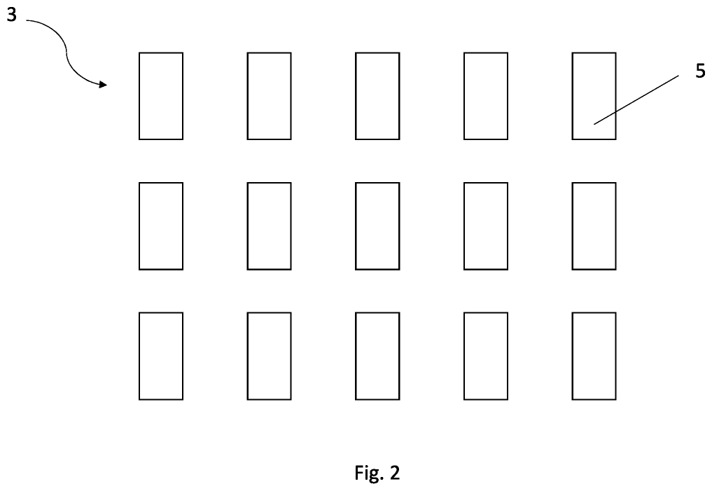

FIG. 2 is a highly schematic diagram of the OMS 3 showing the individual nanostructures 5. These nanostructures have both length and width less than the wavelength of the incident light. There are arranged in a periodically repeating pattern in two directions (horizontally and vertically). Each of the spatial periods is also less than the wavelength of the incident light.

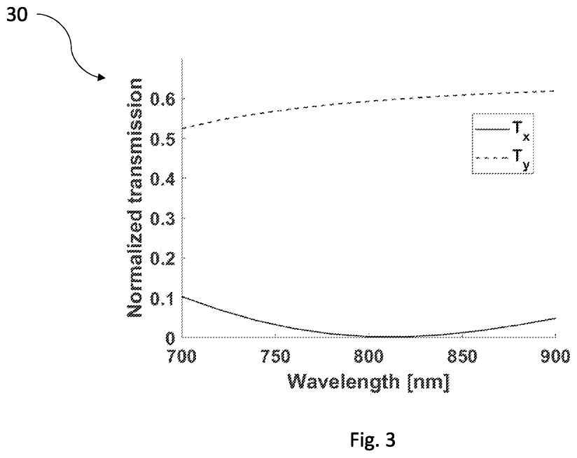

When light linearly polarized along the X and Y axes is incident on the OMS 3, the OMS 3 transmits light which is polarized linearly along the Y axis 12, and reflects light which is polarized linearly along the X axis 14. The inventors have appreciated that whilst transmission and reflection will not in practice be perfect, priority when designing the OMS 3 should be to achieve low transmission (for example, less than 5%) of one polarization state (light linearly polarized in the X axis 14 in the illustrated embodiment), with high transmission of the other polarization state (light linearly polarized along the Y axis 12 in the illustrated embodiment) being a secondary consideration. This is illustrated with reference to FIG. 3.

In the illustrated embodiment each nanostructure is made of gold, and has dimensions of 200 nm by 100 nm, with a thickness of 50 nm. The nanostructures 5 are arranged in a 2-dimensional array with a periodicity of 250 nm. The specific configuration in the illustrated embodiment is designed to perform best when the incident light is monochromatic and has a wavelength of 800 nm.

FIG. 3 is a graph 30 showing the normalized transmission T_{y}. Tₓ, through the OMS 3 of the illustrated embodiment of the light polarized linearly along the Y axis 12, and the light linearly polarized along the X axis 14 respectively, plotted against the incident wavelength. It can be seen from the graph of FIG. 3 that at an incident wavelength of 800 nm, the normalized transmission Tₓ≈0. Whilst the light linearly polarized along the Y axis 12 is not fully transmitted, with the normalized transmission T_{y} being between 0.5 and 0.6 across the wavelength range of 700 nm to 900 nm which is plotted, this transmission is significantly higher than any transmission of the light linearly polarized along the X axis 14, and so the OMS 3 is effective in providing the transmission characteristics outlined above.

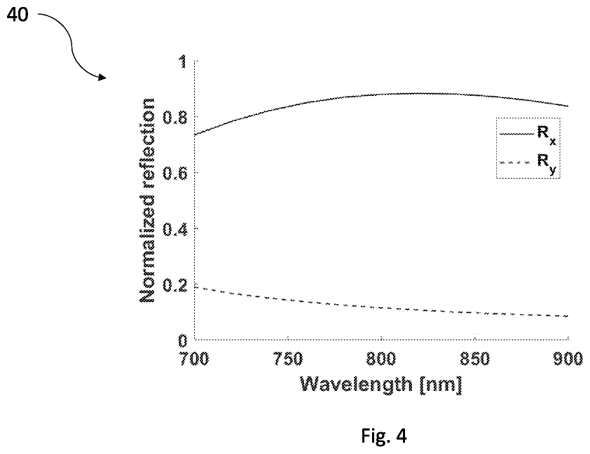

FIG. 4 is a graph 40 showing the normalized reflection R_{y}, Rₓ, from the OMS 3 of the illustrated embodiment of the light polarized linearly along the Y axis 12, and the light linearly polarized along the X axis 14 respectively, plotted against the incident wavelength. In the illustrated embodiment, the OMS 3 is configured to reflect light linearly polarized along the X axis 14, and to transmit light linearly polarized along the Y axis 12, and from the graph 40 of FIG. 4, it can be seen that the normalized reflection Rₓ is much greater (>0.8 at 800 nm) than the normalized reflection R_{y} (<0.2 at 800 nm), again illustrating that the OMS 3 is effective in providing the required characteristics.

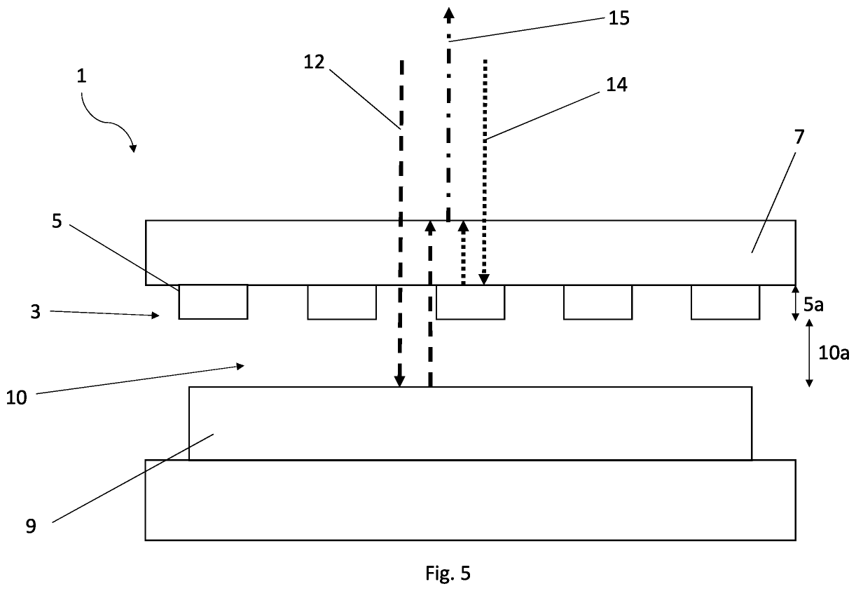

Operation of the device 1 will now be explained with reference to FIG. 1 and FIG. 5. FIG. 1 shows the apparatus 1 with the MEMS mirror 9 in a low position such that the gap 10 between the mirror 9 and the OMS 3 has a relatively large value 10a. FIG. 5 shows the apparatus 1 with the MEMS mirror 9 in a raised position such that the size 10b of the gap 10 between the mirror 9 and the OMS 3 is reduced. As has been discussed above, the OMS 3 substantially reflects the light linearly polarized along the X axis 14 and transmits the light linearly polarized along the Y axis 12 so that it is incident on the mirror 9. The light linearly polarized along the Y axis 12 is reflected by the mirror 9, and once again substantially transmitted by the OMS 3. In this way, after reflection from the apparatus 1, the light linearly polarized along the Y axis 12 (reflected by the mirror 9) combines with the light linearly polarized along the X axis 14 (reflected by the OMS 3) but with a phase difference associated with the additional optical path length to and from the mirror 9. The additional geometric path length is equal to twice the size 10a of the gap 10, plus twice the thickness 5a of the nanostructures 5, and it will be understood that the additional optical path length experienced by the light linearly polarized along the Y axis 12 is approximately equal to this additional physical path length. The optical path length is of course also dependent on the refractive index of the medium of the gap 10 (air in the illustrated embodiment), and the refractive index of the medium of the substrate 7.

Therefore, by adjusting the position of the mirror 9 relative to the OMS 3, as shown in FIG. 5, the additional path length and hence the phase difference between the reflected light linearly polarized along the X axis 14 and the reflected light linearly polarized along the Y axis 12 can be adjusted. The phase difference determines the polarization state of the resulting light 15 reflected from the apparatus and hence the polarization state of the reflected light 15 can be continuously adjusted by continuously adjusting the position of the mirror 9.

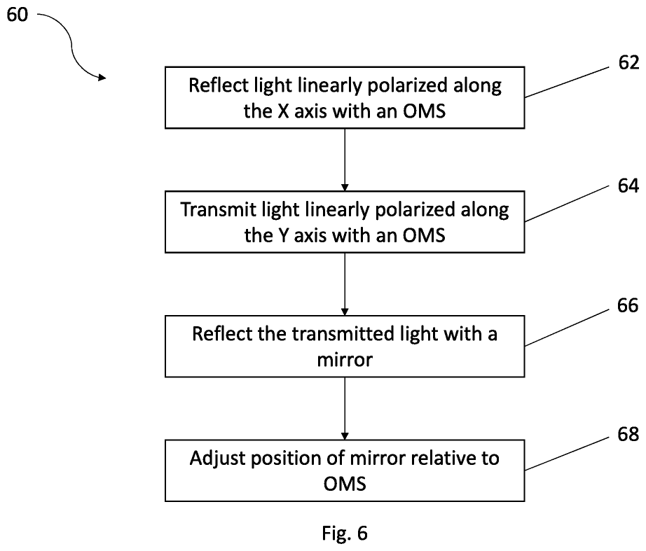

The operation described above is summarized in the flowchart 60 of FIG. 6. At steps 62 and 64 the X and Y polarized light is respectively reflected and transmitted by the OMS 3. The transmitted Y polarized light is reflected by the mirror 9 at step 66 before being transmitted again by the OMS and combining interferometrically with the reflected X polarized light. At step 68 the position of the mirror 9 relative to the OMS 3 is adjusted to give an altered phase difference between X and Y polarizations and thus a different resultant polarization in the interferometric combination.

It will be understood that the explanation of the operation of the device 1 given above has been simplified for clarity, and that there will be reflections within the device in addition to those discussed above. The explanation only takes into account the first reflection from the mirror 9, but in reality, not all of the light reflected by the mirror 9 will be immediately transmitted back through the OMS 3. Rather, there is some reflection from both sides of the OMS 3 and so in theory there could be a large number of reflections back and forth between the mirror 9 and the OMS 3. For example, some light may be transmitted through the OMS 3, reflected from the mirror 9, and then re-transmitted through the OMS 3 immediately as discussed above. Also, some light may be transmitted through the OMS 3, reflected back and forth between the OMS 3 and the mirror 9 a plurality of times, and then transmitted back through the OMS 3. These reflections combine to form a total reflected signal according to the Fabry Perot equation (Equation 1). In the below equation, the medium of the substrate 7 has been designated ‘0’, the medium of the gap 10 has been designated ‘1’, and the medium of the mirror has been designated ‘2’. r_{ab} is the reflection coefficient for light approaching the interface between media a and b from the side of medium a. t_{ab} is the transmission coefficient for light approaching the interface between media a and b from the side of medium a. d is the thickness of medium 1 (the gap 10). λ is the wavelength of the light in medium 1. This equation is identical for both polarization states, however, the reflection and transmission coefficients themselves are dependent on the polarization. The coefficients are also dependent on the angle of the incident light, in this case the equation describes normal incidence.

$${r}_{t o t a l} = {r}_{01} + \frac{{t}_{01} {t}_{10} {r}_{12} {e}^{i 2 β}}{1 - {r}_{10} {r}_{12} {e}^{i 2 β}} \qquad ( 1 )$$

$$β = \frac{2 π}{λ} d$$

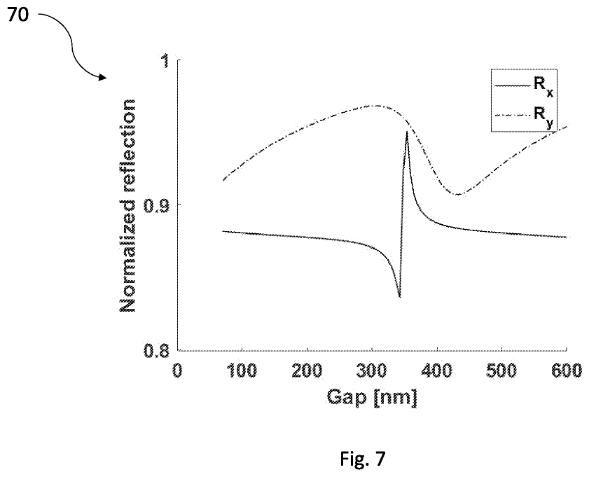

FIG. 7 shows the normalized reflection of both the light linearly polarized along the X axis Rₓ and the light linearly polarized along the Y axis R_{y}, plotted against the gap size 10a.

The light linearly polarized along the X axis 14 is predominantly reflected by the OMS 3, and so it can be seen that for large portions of the graph, Rₓ does not vary significantly with gap size 10a. There is however an anomalous trough and subsequent spike around a gap size of 350 nm. This is caused by the portion of the light linearly polarized along the X axis 14 which is transmitted by the OMS 3, reflected by the mirror 9, and then retransmitted by the OMS 3 interfering with the light linearly polarized along the X axis 14 initially reflected from the OMS when the path difference is equal to a whole wavelength (at a gap size 10a of 350 nm).

Similarly, although the light linearly polarized along the Y axis 12 is predominantly transmitted by the OMS 3, a portion of the light linearly polarized along the Y axis 12 is reflected by the OMS 3, and so the variation of R_{y} with gap size 10a seen in FIG. 7 is associated with interference effects between the light linearly polarized along the Y axis 12 which is transmitted by the OMS 3, reflected by the mirror 9, and then retransmitted by the OMS 3, and the light linearly polarized along the Y axis 12 which is initially reflected from the OMS 3.

The OMS of the illustrated embodiment more effectively reflects the light linearly polarized along the X axis 14 than it transmits the light linearly polarized along the Y axis 12, and hence the interference effects shown in FIG. 7 are more pronounced for R_{y} than for Rₓ.

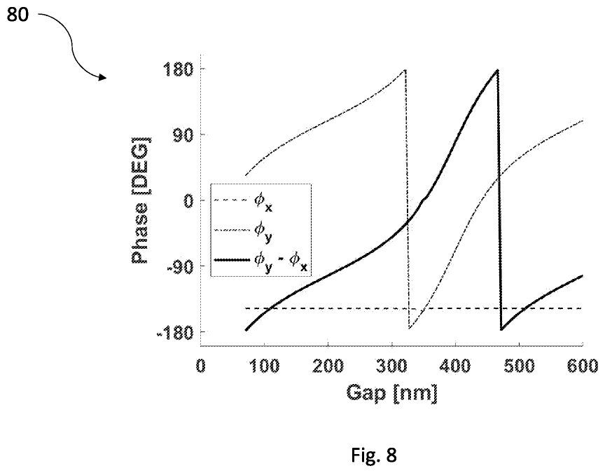

FIG. 8 is a graph 80 showing the phase of the light reflected by the apparatus 1, plotted against the size of the gap 10. It can be seen from the graph 80 that the phase ox of the light linearly polarized along the X axis 14 does not depend on the gap size. This is because, in the illustrated embodiment, the light linearly polarized along the X axis is mostly reflected by the OMS 3, not by the mirror 9. Meanwhile, the phase ϕ_{y} of the light linearly polarized along the Y axis 12 does change with the size of the gap 10. This is because, as explained above, the light linearly polarized along the Y axis 12 is mostly transmitted by the OMS and reflected by the mirror 9, and so has an additional path length which varies with the size of the gap 10. In the illustrated embodiment, the nanostructure thickness 5a is 50 nm. The graph 80 was created using a simulation of light with a wavelength of 800 nm.

The graph 80 also shows the phase difference, ϕ_{y}−ϕₓ, between the light linearly polarized along the Y axis 12, and the light linearly polarized along the X axis 14. The difference ϕ_{y}−ϕₓ should be zero when the additional optical path length experienced by the light linearly polarized along the Y axis 12 is equal to the wavelength, which in the illustrated embodiment occurs for a gap size of approximately 350 nm. Such a result can be seen in graph 80.

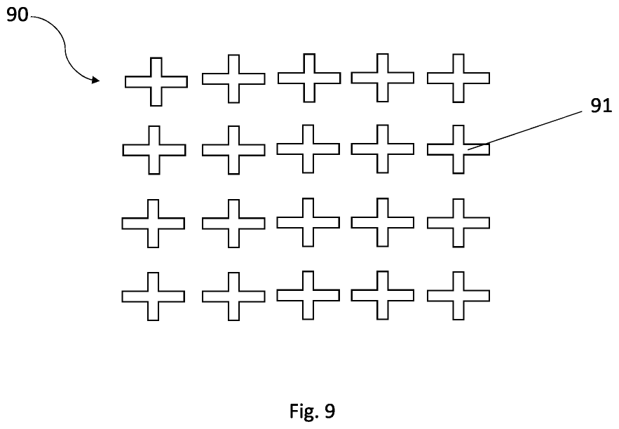

FIG. 9 is a schematic plan view diagram of an OMS 90 with an alternative structure to that of OMS 3 shown in FIG. 2. The OMS 90 comprises individual nanostructures 91 which have a cross-shaped footprint. In another possible variant the nanostructures could be L shaped.

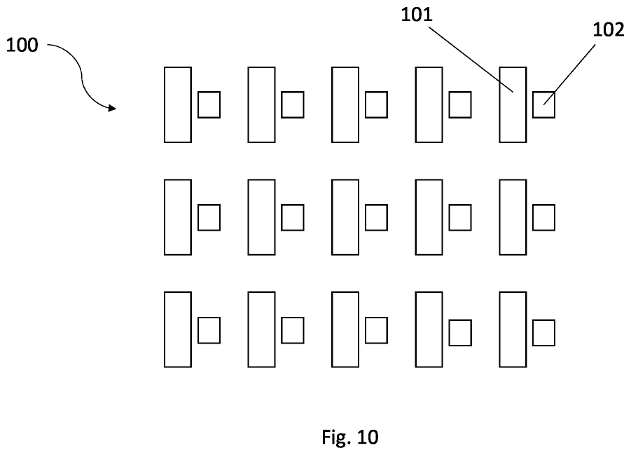

FIG. 10 is a schematic plan view diagram of a further OMS 100. The OMS 100 comprises individual first nanostructures 101 and second nanostructures 102. First nanostructures 101 have a rectangular footprint, and each first nanostructure 101 is accompanied by a second nanostructure 102 which is smaller than the first nanostructure 101, and has a square or rectangular footprint.

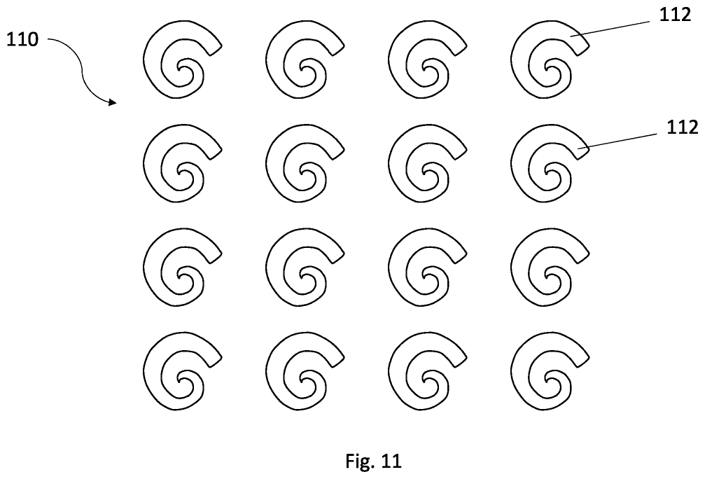

FIG. 11 is a schematic plan view diagram of a further OMS 110. The OMS 110 comprises individual nanostructures 112 which have a spiral-shaped footprint to interact with incident light that has left or right handed circular polarization. The transmitted circular polarization will change handedness when reflected by the mirror 9, but when approaching the spirals 112 from the other side the spirals 112 will also change handedness, thereby allowing the polarization to be transmitted back through the OMS 110.

As with the embodiment of FIG. 2, the nanostructures 91, 101, 102, 112 of FIGS. 9, 10 and 11 have maximum dimensions less than the wavelength of the incident light and are arranged in vertical and horizontal periodically repeating patterns with spatial periods less than the wavelength of the incident light.

The OMS geometries shown in FIGS. 9, 10 and 11 are presented as examples, and it will be understood that OMSs with different geometries may be used in place of the OMS 3 of the illustrated embodiment. More complex geometries such as those shown in FIGS. 9, 10 and 11, give more degrees of freedom when designing the OMS which for example, can allow the functionality of the OMS to be made more broadband.

Further, in the illustrated embodiment, the OMS is constructed from gold, but the skilled person will understand that other metals may be used provided that the nanostructures can be fabricated using the metal. For example, aluminum may be used.

1. An apparatus for adjustably changing the polarization state of incident light having at least a first wavelength, the apparatus comprising:
a polarization changing optical metasurface (OMS) arranged to reflect light of a first polarization state, and to transmit light of a second polarization state, said second polarization state being different to said first polarization state; and
a mirror arranged to reflect the transmitted light of the second polarization state, wherein the apparatus is arranged to move the mirror and/or the polarization changing OMS relative to one another to alter a separation between the polarization changing OMS and the mirror, thereby altering a phase difference between the light reflected by the polarization changing OMS and the light reflected by the mirror such that a combined polarization state of light reflected by the apparatus is adjustable.

2. The apparatus as claimed in claim 1, wherein the polarization changing OMS is configured to predominantly reflect light of the first polarization, and transmit light of the second polarization, independent of the separation between the polarization changing OMS and the mirror.

3. The apparatus as claimed in claim 1, wherein the apparatus is arranged such that said separation between the polarization changing OMS and the mirror has a minimum value of at least 10% of the first wavelength.

4. The apparatus as claimed in claim 1, wherein the apparatus is arranged such that the separation between the polarization changing OMS and the mirror has a maximum value of at most 10 times the first wavelength.

5. The apparatus as claimed in claim 1, wherein the apparatus is arranged to alter the separation between the polarization changing OMS and the mirror between respective minimum and maximum values which differ by at least 9/10 of the first wavelength.

6. The apparatus as claimed in claim 1, wherein the polarization changing OMS is arranged to transmit less than 10% of the light of the first polarization state, and to transmit more than 40% of the light of the second polarization state.

7. The apparatus as claimed in claim 1, wherein the polarization changing OMS is arranged such that the first polarization is orthogonal to the second polarization.

8. The apparatus as claimed in claim 1, arranged to move the mirror relative to the polarization changing OMS.

9. The apparatus as claimed in claim 8, wherein the mirror is a Micro-electromechanical systems mirror.

10. A system comprising:
a light source configured to emit light of at least a first wavelength containing the first polarization state and the second polarization state; and
an apparatus as claimed in any of claims 1 to 9, wherein the light source and apparatus are arranged such that the light emitted by the light source is incident on the apparatus.

11. The system as claimed in claim 10, wherein the light source is configured to emit linearly polarised light.

12. A method of adjustably changing the polarization state of incident light having at least a first wavelength, the method comprising:
reflecting light from said incident light having a first polarization state with a polarization changing OMS;
transmitting light from said incident light having a second polarization state through said polarization changing OMS, said second polarization state being different to said first polarization state;
reflecting the transmitted light of the second polarization state with a mirror;
moving the mirror and/or the polarization changing OMS in order to alter a separation between the polarization changing OMS and the mirror thereby altering a phase difference between the light reflected by the polarization changing OMS and the light reflected by the mirror such that a combined polarization state of light reflected by both the polarization changing OMS and the mirror is adjusted.

13. The method as claimed in claim 12, comprising moving the mirror relative to the polarization changing OMS.

14. The method as claimed in claim 12, wherein the separation between the polarization changing OMS and the mirror has a minimum value of at least 10% of the first wavelength.

15. The method as claimed in claim 12, wherein the separation between the polarization changing OMS and the mirror has a maximum value of at most 10 times the first wavelength.

16. The method as claimed in claim 12, comprising altering the separation between the polarization changing OMS and the mirror between respective minimum and maximum values which differ by at least 9/10 of the first wavelength.
